(19) United States
(12) Patent Application Publication
(10) Pub. No.: US 2014/0349824 A1
(43) Pub. Date: Nov. 27, 2014

(54) TOOL CHANGE DEVICE

(71) Applicant: Industrial Technology Research Institute, Hsin-Chu (TW)

(72) Inventors: KUAN-WEN CHEN, Taichung City (TW); KUN-YING LI, Chiayi City (TW); CHIEN-CHIH LIAO, Taichung City (TW); SHAO-YING HUNG, New Taipei City (TW); SHAO-KU HUANG, Taichung City (TW); YI-MING CHEN, Taichung City (TW)

(73) Assignee: Industrial Technology Research Institute, Hsin-Chu (TW)

(21) Appl. No.: 14/034,818

(22) Filed: Sep. 24, 2013

(30) Foreign Application Priority Data
May 24, 2013 (TW) 102209706

(51) Int. Cl. B23Q 3/12

(52) U.S. Cl. CPC B23Q 3/12
USPC 483/30

(57) ABSTRACT

The present invention relates to a tool change device, which comprises: a base, being arranged for enabling the same to move reciprocatingly between a first position and a second position; a guiding block, formed with a first engaging part and a second engaging part that are serially connected to each other; a lever, formed with a pivot point, a first end and a second end that are arranged opposite to each other while allowing the pivot point to be arranged therebetween; and a spindle, configured with a drive mechanism to be used for connecting the spindle to a tool, being disposed mounting on the base for allowing the same to move in synchronization with the reciprocating movement of the base; wherein, the lever is pivotally coupled to the base by the pivot point thereof for enabling the lever to move in synchronization with the reciprocating movement of the base.

### CROSS REFERENCE TO RELATED APPLICATION

This application also claims priority to Taiwan Patent Application No. 102209706 filed in the Taiwan Patent Office on May 24, 2013, the entire content of which is incorporated herein by reference.

### TECHNICAL FIELD

The present disclosure relates to a tool change device, and more particularly, to a synchronized tool change device that is adapted for a built-in spindle through the cooperation of a lever mechanism.

### BACKGROUND

With rapid technical advance and increasing popularity of 3C products, the need of more advance and efficient machine tool for electronic industry of 3C products is becoming more and more desirable. Recently, among the machinery specialized in the making of housings for 3C products, the center attraction is a high-speed multi-function machine center for milling, drilling and tapering that is able to perform a continuous milling-drilling-tapering process upon a housing of 3C product. However, for obtaining higher machining efficiency, in addition to the effort for improving machining process and machine platform, the time wasted in the changing of cutting tools in such high-speed multi-function machine centers must be reduced.

Currently, most conventional high-speed multi-function machine centers use a too change device adopting the design of direct-drive spindle, whereas there are two type of direct-drive spindle, i.e. a direct-drive spindle with hydraulic cylinder and a direct-drive spindle without hydraulic cylinder. It is known that the tool changing operation for a direct-drive spindle without hydraulic cylinder is enabled in a mechanical manner, while the tool changing operation for a direct-drive spindle with hydraulic cylinder is enabled and driven by the driving force of its hydraulic cylinder. Generally speaking, although the direct-drive spindle is less costly and can produce larger output, but it is disadvantageous in that: (i) the assembly using the direct-drive spindle can be too long in length, causing the assembly to have a low nature frequency that is not good for any high-speed operation; (ii) the motor for driving the direct-drive spindle can be bulky, high inertia motor that is heavy and not able to perform well in operations requiring frequency or instant acceleration/deceleration, and consequently, when the direct-drive spindle is designed to be mounted on the head of a platform, the stiffness of the head must be strengthened for resisting vibration as the direct-drive spindle can easily become a source of vibration; (iii) the concentricity between the spindle, the motor and the coupling must be ensured, since any slightly misaligned can cause high-frequency vibration that can damage the spindle bearing.

Moreover, there is a small portion of conventional high-speed machine center adopts the design of built-in spindle, and similarly there are also two types of built-in spindle, i.e. the built-in spindle with hydraulic cylinder and the built-in spindle without hydraulic cylinder. Notably, the tool changing operation for a built-in spindle with hydraulic cylinder is enabled and driven by the driving force of its hydraulic cylinder, whereas the built-in spindle with hydraulic cylinder is disadvantageous in that: (i) the structure of the built-in spindle can be too long in length; (ii) the cost of the hydraulic cylinder can be very high that it may take up to 20%˜30% of the overall cost; (iii) although the tool changing speed can be increased by the increasing of hydraulic pressure, such increase in tool changing speed is not very significant. In addition, for those built-in spindles without hydraulic cylinder, they are disadvantageous in that: any tool changing operation for a built-in spindle without hydraulic cylinder can only be enabled with the cooperation of a very complex linkage mechanism since the tool changing operation.

### SUMMARY

In an exemplary embodiment, the present disclosure provides a tool change device, which comprises: a base, being arranged for enabling the same to move reciprocatingly between a first position and a second position; a guiding block, formed with a first engaging part and a second engaging part that are serially connected to each other; a lever, formed with a pivot point, a first end and a second end that are arranged opposite to each other while allowing the pivot point to be arranged therebetween; and a spindle, configured with a drive mechanism to be used for connecting the spindle to a tool, being disposed mounting on the base for allowing the same to move in synchronization with the reciprocating movement of the base; wherein, the lever is pivotally coupled to the base by the pivot point thereof for enabling the lever to move in synchronization with the reciprocating movement of the base while allowing the opposite first end and the second end to swing about the pivot point in relative to each other; during the moving of the base from the first position to the second position, the lever and the spindle are being driven to move in synchronization with the movement of the base, thereby enabling the first engaging part to exert a first force upon the first end while enabling the second end to exert a second force in synchronization upon the drive mechanism for driving the drive mechanism to release the tool.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a tool change device according to an embodiment of the present disclosure.

FIG. 2 and FIG. 3 are sequential views illustrating the motions of the tool change device of FIG. 1.

FIG. 4 is a three-dimensional view of a tool change device according to another embodiment of the present disclosure.

FIG. 5 is a partially enlarged view of the tool change device of FIG. 4.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

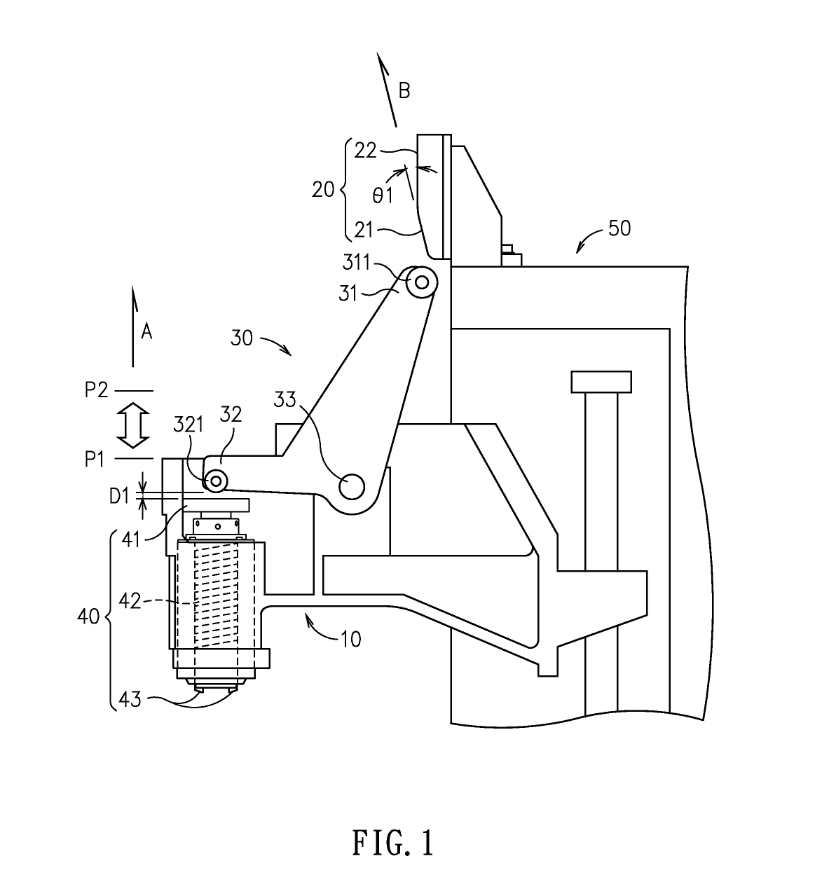

Please refer to FIG. 1, which is a schematic diagram showing a tool change device according to an embodiment of the present disclosure. As shown n FIG. 1, the present disclosure provides a tool change device, which comprises: a base 10, a guiding block 20, a lever 30 and a spindle 40.

The base 10 is movably mounted on a platform 50 while allowing the same to move reciprocatingly between a first position P1 and a second position P2. In the embodiment shown in FIG. 1, the base 10 is arranged for enabling the same to move up and down in a direction parallel to a first direction A. In FIG. 1, the base 10 is positioned at the first position P1. It is noted that the base 10 can be driven to move by various driving devices without any restriction, such as motor, gear assembly, screw rod unit, rack assembly, pneumatic device, hydraulic device, and so on.

The guiding block 20 is fixedly mounted to the platform 50 and is formed with a first engaging part 21 and a second engaging part 22 that are serially connected to each other. In addition, the second engaging part 22 is arranged extending in a direction parallel to the first direction A; the first engaging part 21 is arranged extending in a direction parallel to a second direction B; and there is an included angle θ₁ that is smaller than 90 degrees and is formed between the first direction A and the second direction B.

The lever 30 is formed with a first end 31 and a second end 32 that are arranged opposite to each other. In the embodiment shown in FIG. 1, the first end is configured with a roller bearing 311 and the second end 32 is configured with at least one roller 321, and there is further a pivot point 33 formed on the lever 30 at a position between the first end 31 and the second end 32 that is to be used for the lever to pivotally couple to the base 10 thereby for allowing the opposite first end 31 and the second end 32 to swing about the pivot point in relative to each other in a seesaw manner. Moreover, the lever 30 can be driven to move in synchronization with the reciprocating movement of the base 10.

The spindle 40, being a built-in spindle without hydraulic cylinder in the embodiment, is disposed in the base 10 for allowing the same to be driven to move in synchronization with the reciprocating movement of the base 10. In FIG. 1, the spindle 40 is configured with a drive mechanism, and the drive mechanism is this embodiment is configured with a tool-changing ring 41, a disc spring 42 and a gripper set 43 in a manner that the disc spring 42 is used for connecting the tool-changing ring 41 to the gripper set 43, the gripper set 43 that is designed with a clapping status and a releasing status is used for holding a tool when it is situated in the clapping status, and is enabled to release the tool when it is situated in the releasing status.

The relative positioning of the guiding block 20, the lever 30 and the spindle 40 can be described as following: the guiding block 20 and the spindle 40 are disposed respectively at two opposite sides of the lever 30 at a position corresponding to the pivot point 33, while allowing the guiding block 20 and the first end 31 of the lever 30 to be disposed at the same side of the pivot point 33, i.e. to the right of the pivot point 33, and the spindle 40 and the second end 32 to be arranged together at another side of the pivot point 33, i.e. to the left of the pivot point 33.

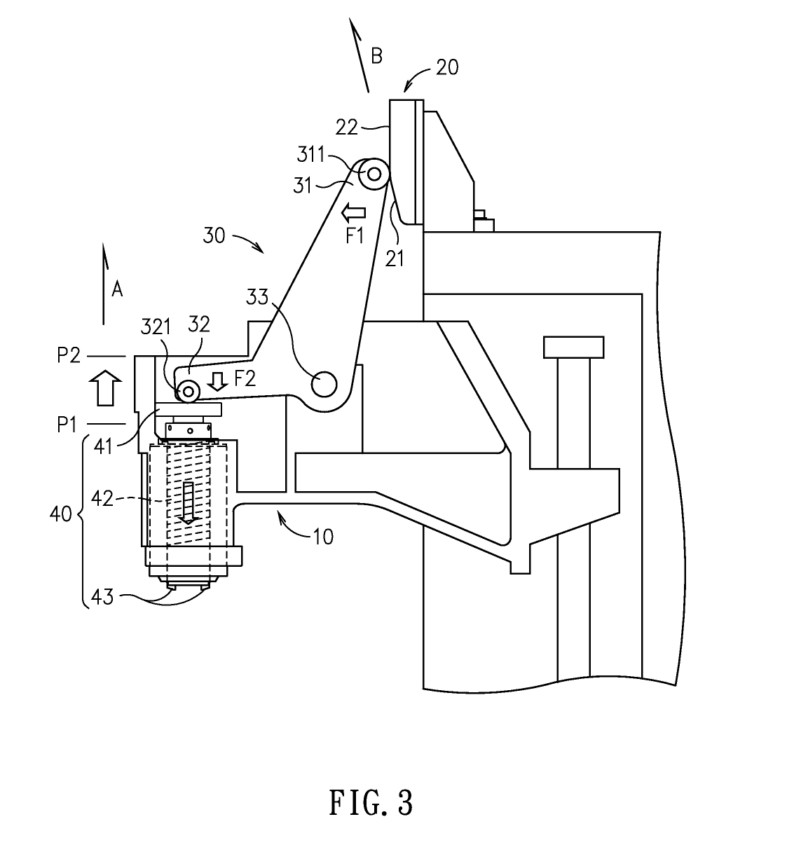

Please refer to FIG. 1 and FIG. 3, which are sequential views illustrating the motions of the tool change device of the present disclosure. As shown in FIG. 1, when the base 10 is positioned at the first position P1, the roller bearing 311 on the first end 31 of the lever 30 is separated from the guiding block 20 and the roller 321 on the second end 32 of the lever 30 is spaced from the tool-changing ring 40 by a specific distance D1. In addition, since the roller 321 on the second end 32 is not engaged to the tool-changing ring 41, the gripper set 43 is situated in the gripping status for allowing the same to fixedly holding a tool.

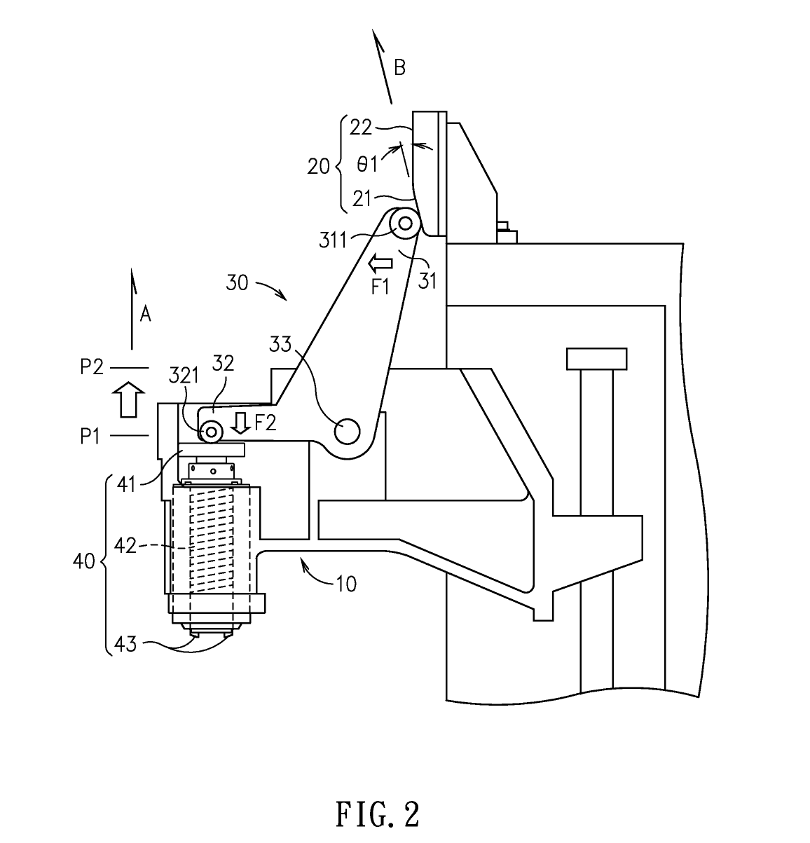

In FIG. 2, when the base 10 is driven to move in a direction parallel to the first direction A upward to the second position P2, the lever 30 and the spindle 40 are simultaneously being driven to move upward as well, and thereby, the roller bearing 311 on the first end 31 of the lever 30 is driven to abut against the first engaging part 21 of the guiding block 20. Consequently, by the ramp formed on the first engaging part 21 that is inclined parallel to the second direction B and the small-than-90-degree included angle formed between the first direction A and the second direction B, the first engaging part 21 is enabled to exert a first force F1, i.e. a trust, upon the roller bearing 311 on the first end 31 of the lever 30, and also simultaneously exerts a downward second force F2 upon the second end 32 of the lever 30 for enabling the roller 321 on the second end 32 of the lever 30 to engage to the tool-changing ring 41. However, at this moment, the second force F2 of the roller 321 that is exerting on the tool-changing ring 41 is not sufficient enough for switching the operation status of the gripper set 43 from the gripping status to releasing status.

As shown in FIG. 3, when the base 10 is moved to the second position P2, the roller bearing 311 on the first end 31 of the lever 30 is moved from the first engaging part 21 to the second engaging part 22, and at this moment, the second force F2 of the roller 321 that is exerting on the tool-changing ring 41 is large enough for forcing the tool-changing ring 41 to move downward and pressing upon the disc spring 42 to stretch out, and thus enable the gripper set 43 to switch from the gripping status to releasing status for releasing the tool. Moreover, during the tool releasing of the gripper set 43, a tool changing operation can be enabled, and after the tool changing operation is completed, the base 10 is driven to move downward from the second position P2 to the first position P1 for allowing the roller 321 to move away from engaging to the tool-changing ring 41 so as to enable to the gripper set 43 to switch from the releasing status to the gripping status for fixedly holding the new tool. That is, when the tool change device of the present disclosure is enabled to move sequentially from FIG. 1 to FIG. 3, it is performing a tool releasing process, and on the other hand, when the tool change device of the present disclosure is enabled to move backwardly from FIG. 3 to FIG. 1, it is performing a tool gripping process. Thus, the combination of the forward tool releasing process and the backward tool gripping process is a complete tool changing operation.

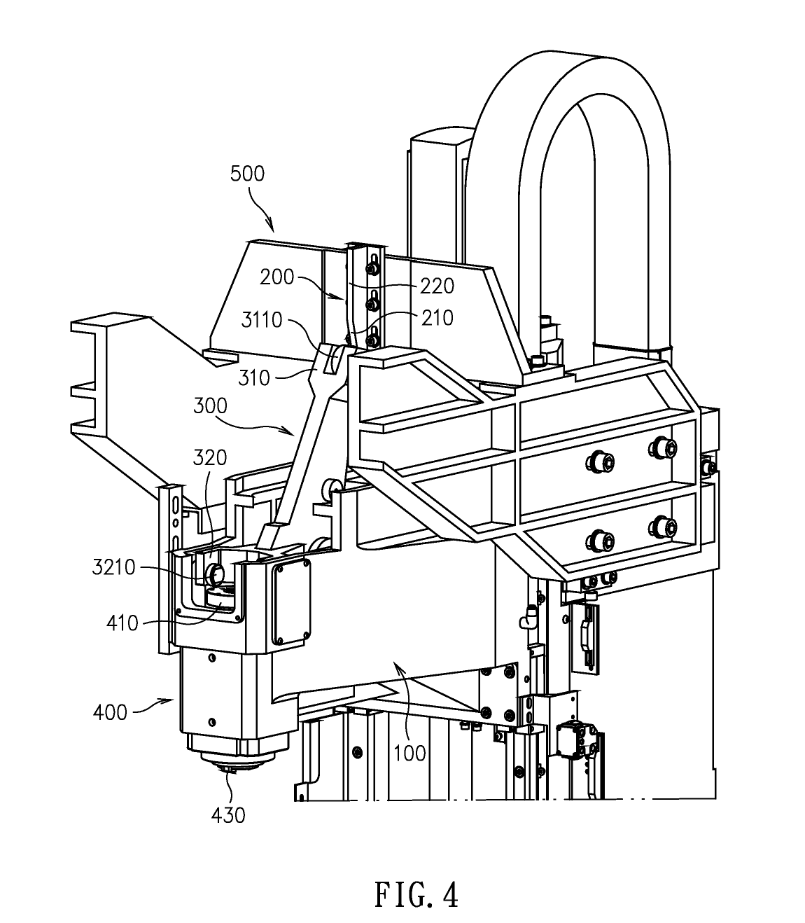

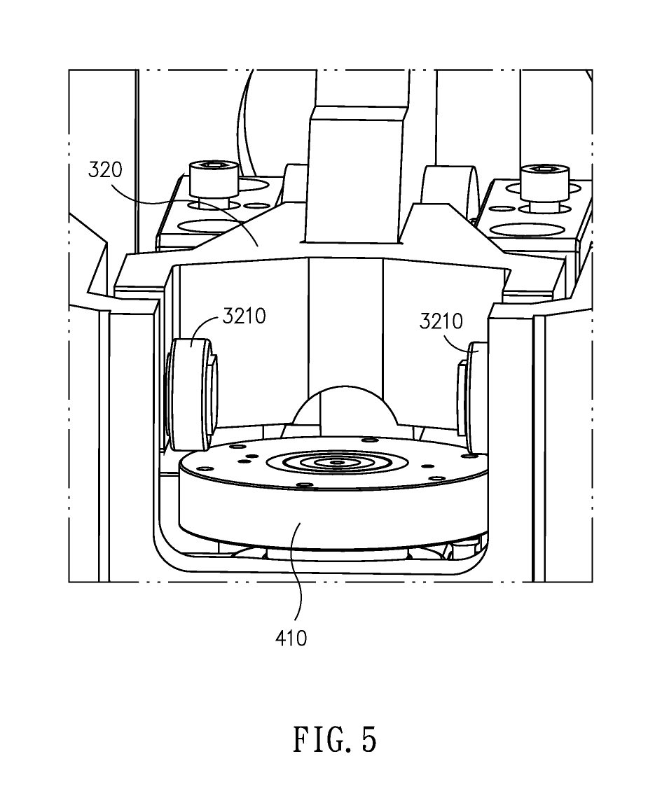

Please refer to FIG. 4 and FIG. 5, which are respectively a three-dimensional view of a tool change device according to another embodiment of the present disclosure, and a partially enlarged view of the tool change device of FIG. 4. Similarly, the tool change device of FIG. 4 is comprised of: a base 100, a guiding block 200, a lever 300 and a spindle 400, wherein the base 100 is movably disposed on a platform 500; the guiding block 20 is fixedly mounted to the platform 500; the lever 300 is pivotally coupled to the base 100 for enabling the same to move in synchronization with the reciprocating movement of the base 100; and the spindle 400 is disposed on the base 100 for enabling the same to move in synchronization with the reciprocating movement of the base 100. In this embodiment, the first end 310 of the lever is formed as a fork-like structure, whereas there is a roller bearing 3110 disposed inside the fork-like first end 310. Thereby, when the lever 300 is moving in synchronization with the reciprocating movement of the base 100, the roller bearing 311 is supported by the fork-like first end 310 so as to engage firmly to the guiding block 200 and thus slide smoothly back and forth between the first engaging part 210 and the second engaging part 220. Moreover, the second end 320 of the lever is also formed as a fork-like structure, whereas there are two rollers 3210 arranged inside the fork-like second end 320 respectively at two opposite sides thereof. The two rollers 3210 are capable of evenly pressing on the two sides of the tool-changing ring 410 for controlling the releasing/gripping of the gripper set 430.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A tool change device, comprising:
a base, being arranged for enabling the same to move reciprocatingly between a first position and a second position;
a guiding block, formed with a first engaging part and a second engaging part that are serially connected to each other;
a lever, formed with a pivot point, a first end and a second end in a manner that the first and the second ends are arranged opposite to each other while allowing the pivot point to be arranged therebetween; and
a spindle, configured with a drive mechanism to be used for connecting the spindle to a tool, being disposed mounting on the base for allowing the same to move in synchronization with the reciprocating movement of the base;
wherein, the lever is pivotally coupled to the base by the pivot point thereof for enabling the lever to move in synchronization with the reciprocating movement of the base while allowing the opposite first end and the second end to swing about the pivot point in relative to each other; and during the moving of the base from the first position to the second position, the lever and the spindle are being driven to move in synchronization with the movement of the base, and thereby enabling the first end to move from the first engaging part to the second engaging part so as to consequently allowing the second engaging part to exert a first force upon the first end while synchronously enabling the second end to exert a second force upon the drive mechanism for driving the drive mechanism to release the tool.

2. The tool change device of claim 1, wherein the spindle is a built-in spindle without hydraulic cylinder.

3. The tool change device of claim 1, wherein the second engaging part is arranged extending in a direction parallel to the first direction; the first engaging part is arranged extending in a direction parallel to the second direction; and there is an included angle that is smaller than 90 degrees and is formed between the first direction and the second direction.

4. The tool change device of claim 1, wherein the guiding block and the spindle are disposed respectively at two opposite sides of the lever at a position corresponding to the pivot point, while allowing the guiding block and the first end to be disposed at the same side of the pivot point, and the spindle and the second end to be arranged together at another side.

5. The tool change device of claim 1, wherein the second end is configured with two rollers in a manner that the two rollers are capable of evenly pressing on the drive mechanism for releasing the tool.

6. The tool change device of claim 1, wherein the first end is configured with a roller bearing in a manner that the roller bearing is enabled to abut against the first engaging part and the second engaging part when the lever is being driven to move in synchronization with the reciprocating movement of the base.

7. The tool change device of claim 1, wherein the drive mechanism is configured with a tool-changing ring, a disc spring and a gripper set in a manner that the disc spring is used for connecting the tool-changing ring to the gripper set, the gripper set is used for holding the tool; and when the second force is exerted upon the tool-changing ring, the disc spring is pressed for forcing the same to be stretched out so as to enable the gripper set to release the tool.

8. The tool change device of claim 1, wherein the first end of the lever is separated from the guiding block when the base is positioned at the first position, while the second end of the lever is spaced from the tool-changing ring by a specific distance.

9. The tool change device of claim 1, wherein the base is designed to be movably disposed on a platform, while the guiding block is fixedly mounted on the platform.
